(19) United States
(12) Patent Application Publication
(10) Pub. No.: US 2016/0301693 A1
(43) Pub. Date: Oct. 13, 2016

(54) SYSTEM AND METHOD FOR IDENTIFYING AND PROTECTING SENSITIVE DATA USING CLIENT FILE DIGITAL FINGERPRINT

(71) Applicants: Maxim Nikulin, Moscow (RU); Sergey Plisyuk, Zheleznodorozhniy (RU)

(72) Inventors: Maxim Nikulin, Moscow (RU); Sergey Plisyuk, Zheleznodorozhniy (RU)

(21) Appl. No.: 14/683,303

(22) Filed: Apr. 10, 2015

(51) Int. Cl. H04L 29/06; H04L 9/32

(52) U.S. Cl. CPC H04L 63/0876; H04L 9/3247; H04L 63/20

(57) ABSTRACT

Disclosed are a system and method for identifying and protecting sensitive data contained in a network client's file comprising obtaining a plurality of available digital fingerprint categories from a fingerprint-evaluating server, generating said file's digital fingerprint using said plurality of said digital fingerprint categories obtained from said server, transmitting said file's digital fingerprint to said server, comparing said digital fingerprint to a plurality of digital fingerprints stored in a database, detecting whether a match between said generated digital fingerprint and at least one of said plurality of said digital fingerprints stored in said database is found, and designating said file as containing or not containing sensitive data according to established data protection policies.

### FIELD OF THE INVENTION

The present invention generally relates to data identification and data loss prevention systems. Specifically, the present invention a method for identifying and protecting sensitive data contained in a network client file using said file's digital fingerprint.

### BACKGROUND OF THE INVENTION

Data Loss Prevention (DLP) systems are designed for detecting and preventing data security breaches by monitoring, detecting and blocking sensitive data while in-use, in motion, i.e., network traffic, and at rest, i.e., data storage. In said data security breaches data leakage incidents occur where sensitive data is disclosed to unauthorized users either by malicious intent or through an inadvertent mistake. Such sensitive data could come in the form of private company HR information, corporate or personal financial information, intellectual property, privileged client or patient information, credit card data, or any other sensitive information that can vary depending on business type or industry.

The terms “data loss” and “data leak” are closely related and are often used interchangeably, however distinction must be made as these terms are different. Data loss incidents turn into data leak incidents in cases where said sensitive data is lost and subsequently acquired by an unauthorized party. Furthermore, a data leak is possible without the data being lost to begin with such as in cases of it copied or it being misplaced in a less secure storage. It is of paramount importance to control and prevent said data leaks. Some other terms associated with data leakage prevention are: information leak detection and prevention (ILDP), information leak prevention (ILP), content monitoring and filtering (CMF), information protection and control (IPC), and extrusion prevention systems (EPS).

Today, there exist several types of DLP system categories that differ based on the type of data loss prevention that they offer. Network DLP—also known as “data in motion”—is typically a software or hardware solution that is installed at network egress points of the network's perimeter. This solution primarily analyzes network traffic to detect sensitive data that is being sent in violation of said network's data security policies.

Further, there is “Endpoint” DLP, also known as “data in use”, which runs on end-user workstation or servers in the organization. This type of DLP can address internal as well as external communications, and can therefore be used to control data flow between the groups or between the types of users. For example it can address a problem of protecting sensitive data between outside clients and servers inside a DMZ.

Data leakage detection DLP is concerned with locating sensitive data in unauthorized places, such as on the Web or on a user's workstation and thereafter establishing the source of a data leak.

Data at rest DLP specifically refers to old archived information that might be stored on either a client PC hard drive, on a network storage drive, remote file server or on a backup system such as tape or a CDE media. Such stored or “warehoused” data is of great concern to businesses and government institutions because the longer data is left unused in storage the more likely it might be retrieved by unauthorized parties.

Finally and most relevant to the present invention there are Data Identification DLP solutions that include a number of techniques for identifying confidential or sensitive information in users' files. There are numerous methods for describing sensitive content for its identification. They can be divided into precise methods, such as actual content registration, and imprecise methods, such as analysis of keywords, lexicons, regular expressions, extended regular expressions, meta data tags, Bayesian analysis, statistical analysis, and the like.

Precise methods require actual content registration for subsequent comparison with suspect data. As such, it utilizes a lot of available bandwidth, which presents a serious problem for other applications and for speed of said applications' responses. Imprecise methods, while resolving the bandwidth overutilization problem are prone to providing false positive identifications.

Thus, there exists a need for providing an improved method and system for identifying and protecting sensitive data contained in a network client, whereas such identification is performed with high precision and with low network bandwidth utilization.

### SUMMARY OF THE INVENTION

The present invention presents an improved Data Identification (DLP) solution that offers a method and system for identifying and protecting sensitive data stored in a network client file using said file's digital fingerprint.

A digital fingerprint is defined as a short tag for a larger data object and is a function of checksum-type algorithms, such as CRC32 and other cyclic redundancy checks. The digital fingerprint is intended for providing identification to data files that contain sensitive or protected information.

In one embodiment there is a method for identifying and protecting sensitive data contained in a network client file using said file's digital fingerprint, said method comprising: obtaining available digital fingerprint categories from a fingerprint-evaluating server; generating digital fingerprint, said generation is done based on said categories obtained from said server; comparing said generated digital fingerprint to the fingerprints stored in a database; detecting whether or not a match is found, and designating said file as containing sensitive data or clearing the file according to established policies.

Another embodiment provides a system for identifying and protecting sensitive data contained in a network client file using said file's digital fingerprint, said system comprising: at least one processing unit; memory operably associated with said at least one processing unit; a generating tool storable in said memory and executable by said processing unit, said generating tool is configured to generate a digital fingerprint of said file using a plurality of digital fingerprint categories obtained from a fingerprint evaluating server; a detecting tool storable in memory and executable by said at least one processing unit, said detecting tool configured to detect matches between said generated digital fingerprint and at least one of a plurality of digital fingerprints stored in a local database; and a designating tool storable in memory and executable by said at least one processing unit, said designating tool is configured to designate said client's file according to established data policies based on said matches between said generated digital fingerprint and said plurality of digital fingerprints stored in a local database.

In another embodiment there is a computer-readable medium storing computer instructions, which when executed, enable a computer system to identify and protect sensitive data contained in a network client file using said file's digital fingerprint, comprising computer instructions for: generating said file's digital fingerprint using a plurality of digital fingerprint categories obtained from a fingerprint-evaluating server; comparing said generated digital fingerprint to a plurality of digital fingerprints stored in said client's database; detecting whether a match between said generated digital fingerprint and at least one of said plurality of digital fingerprints stored in said local database is found, and designating said file according to established data protection policies.

And yet another embodiment provides a method for deploying a tool for identifying and protecting sensitive data contained in a network client file using said file's digital fingerprint, said method comprising: providing a computer infrastructure operable to: obtain a plurality of available digital fingerprint categories from a fingerprint-evaluating server; generate digital fingerprint of said file, said generation is done based on said plurality of available digital fingerprint categories obtained from said server; compare said generated digital fingerprint to a plurality of fingerprints stored in a local database; detect whether a match between said generated digital fingerprint and at least one of said plurality of digital fingerprints stored in said local database is found, and designate said file according to established policies.

### BRIEF DESCRIPTION OF THE DRAWINGS

FIG. 1 shows a schematic of an exemplary computing environment in which elements of the present invention may operate;

FIG. 2 depicts a process of a digital fingerprint generation based on plurality of available digital fingerprint categories the process of digital fingerprint generation based on a plurality of available digital fingerprint categories;

FIG. 3 illustrates a computer implemented system configured to compare a digital fingerprint to a plurality of fingerprints stored in a local database.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to a method and a system for identifying and protecting sensitive data contained in a network client file using said file's digital fingerprint.

In one embodiment there is a method for identifying and protecting sensitive data contained in a network client file using said file's digital fingerprint, said method comprising: obtaining available digital fingerprint categories from a fingerprint-evaluating server; generating digital fingerprint, said generation is done based on said categories obtained from said server; comparing said generated digital fingerprint to the fingerprints stored in a local database; detecting whether or not a match is found, and designating said file as containing sensitive data or clearing the file according to established policies.

Other embodiment provides a system for identifying and protecting sensitive data contained in a network client file using said file's digital fingerprint, said system comprising: at least one processing unit; memory operably associated with said at least one processing unit; a generating tool storable in said memory and executable by said processing unit, said generating tool is configured to generate a digital fingerprint of said file using a plurality of digital fingerprint categories obtained from a fingerprint evaluating server; a detecting tool storable in memory and executable by said at least one processing unit, said detecting tool configured to detect matches between said generated digital fingerprint and at least one of a plurality of digital fingerprints stored in a local database; and a designating tool storable in memory and executable by said at least one processing unit, said designating tool is configured to designate said client's file according to established data policies based on said matches between said generated digital fingerprint and said plurality of digital fingerprints stored in a local database.

In another embodiment there is a computer-readable medium storing computer instructions, which when executed, enable a computer system to identify and protect sensitive data contained in a network client file using said file's digital fingerprint, comprising computer instructions for: generating said file's digital fingerprint using a plurality of digital fingerprint categories obtained from a fingerprint-evaluating server; comparing said generated digital fingerprint to a plurality of digital fingerprints stored in said client's database; detecting whether a match between said generated digital fingerprint and at least one of said plurality of digital fingerprints stored in said local database is found, and designating said file according to established data protection policies.

And yet another embodiment provides a method for deploying a tool for identifying and protecting sensitive data contained in a network client file using said file's digital fingerprint, said method comprising: providing a computer infrastructure operable to: obtain a plurality of available digital fingerprint categories from a fingerprint-evaluating server; generate digital fingerprint of said file, said generation is done based on said plurality of available digital fingerprint categories obtained from said server; compare said generated digital fingerprint to a plurality of fingerprints stored in a local database; detect whether a match between said generated digital fingerprint and at least one of said plurality of digital fingerprints stored in said local database is found, and designate said file according to established policies.

A digital fingerprint is defined as a short tag for a larger data object and is a function of checksum-type algorithms, such as CRC32 and other cyclic redundancy checks, and intended for providing identification of whether a given data file contains sensitive or protected information.

Fingerprints of two distinct data files will have different fingerprints no matter how insignificantly the files differ. Thus, if a digital fingerprint of a file that contains confidential or sensitive information is known, and another file has a similar digital fingerprint, there is a high probability that the files are the same, which means that the second file contains the sensitive information of the first file.

By storing copies of files' digital fingerprints in a database, it becomes possible to compare a digital fingerprint of a subject file against the database and determine whether the subject file contains sensitive data. If the match is found, the subject file contains sensitive data, and if there is no match, —it does not.

Existing solutions, such as shingling, where a shingle is defined as contiguous subsequences of words sometimes called “q-grams”, Support Vector Machines (SVM), DB Fingerprint, iMatch, and the like are based on patterns searches and analysis, and usually involve sending a subject data file from an individual client to a fingerprint-evaluating server, and, consequentially, generating and evaluating fingerprints of said file by said server, and then, depending on a result of the evaluation, either transmitting the file back to the client or quarantining it.

Understandably, the efficiency of such solutions depends on the number of participating clients and the network bandwidth, and may work well while the network traffic is low and the number of participating clients is moderate and manageable. However, with the proliferation of mobile devices capable of exchanging data, the volume of data associated with transmitting subject files from each participating client to the server becomes prohibitively high, and the resulting increased network traffic makes digital fingerprint evaluation slow, unreliable, and prone to data loss and interceptions by wrongdoers.

Instead, the present invention offers an improved system and method for generating a digital fingerprint of a data file at a participating client, sending not the file itself, but its digital fingerprint to a fingerprint-evaluating server for the evaluation, and matching the subject matter fingerprint against a database containing digital fingerprints associated with sensitive data.

The proposed solution is based on the following topology: a) a client, at a predetermined time interval or upon an occurrence of a certain event, requests available digital fingerprint categories from a fingerprint-evaluating server; b) the server relays the requested categories to the client; c) the client generates the file's digital fingerprint and transmits said digital fingerprint to the server over a network; d) the server compares transmitted digital fingerprint to the fingerprints stored in a database; e) the server relays to the client whether or not the match is found, and, if it is, the list of matching records; and t) the client, according the established policies, either designates the files as containing sensitive information or clears it.

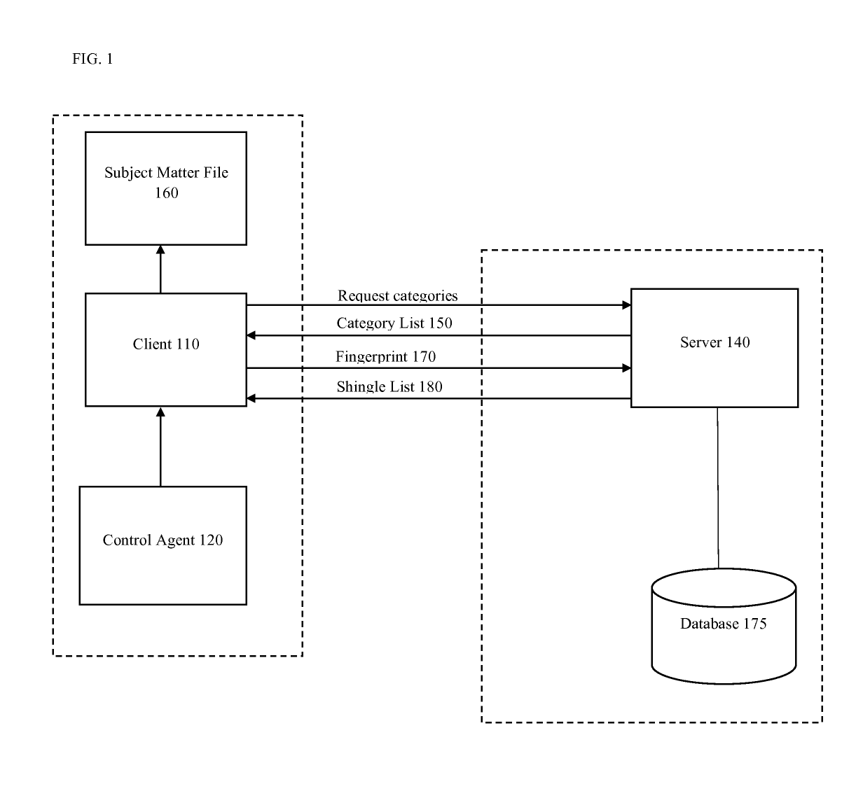

FIG. 1 describes an exemplary computer implemented embodiment of the present invention utilizing a shingle-based approach. Client 110, upon an instruction issued by a perpetually running sensitive information control agent 120, requests a list of all available categories of fingerprints from a fingerprint-evaluating Server 140.

The control Daemon 120 is configured to issue said instruction either periodically based on a pre-defined time interval, or upon an occurrence of a certain event, for example, the daemon's restart. The categories of fingerprints are business-specific and developed in accordance with business processes of a given enterprise.

Further referring to FIG. 1, Server 140 relays the requested List 150 back to Client 110. In some embodiments, list 150 comprises the names of each category N, the minimum length of the word W in each category N, an array containing common, non-sensitive words that can be used in any document, rules pertaining to not linguistically-based alpha-numeric constructs, such as automobile license plates, telephone numbers and the like, the maximum length of the shingle S, the requisite precision of the fingerprint evaluation P.

In some embodiments, precision P is selected from the group consisting of “Precise”, “Recommended” and “Quick”, while in other embodiments P is represented by a percentage point.

We are continuing with FIG. 1. Based on List 150 and subject matter File 160, Client 110 generates digital Fingerprint 170, and transmits it to Server 140. Server 140 evaluates Fingerprint 170 by matching it against Database 175 with the requisite precision P. Once the evaluation is completed, Server 140 generates a list of matching shingles 180 and relays it back to Client 110. Upon receiving List 180, Client 110 logs it and designates File 160 as either containing sensitive information or not.

It should be noted that the similar topology is followed when the evaluation is conducted based on other known solutions, such as Support Vector Machines (SVM), DB Fingerprint, Match and the like.

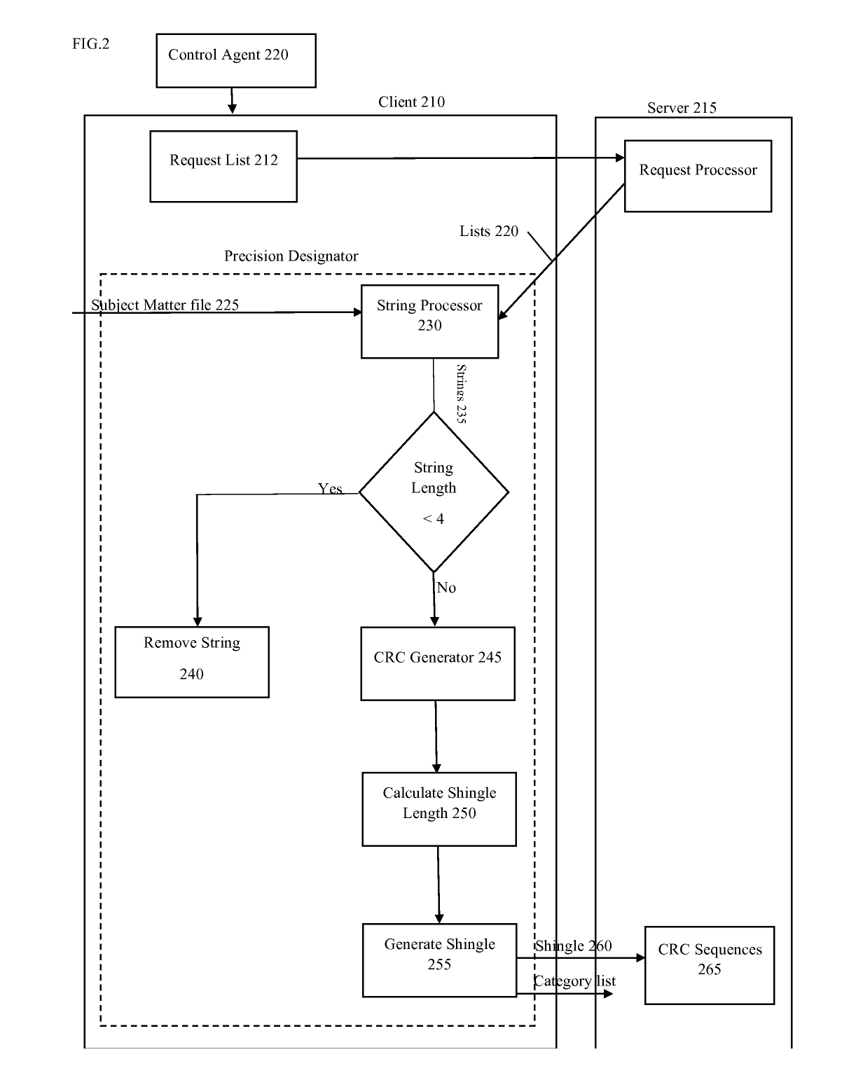

Referring now to FIG. 2, another exemplary embodiment of the present invention is described. Upon an instruction issued by a perpetually running sensitive information control agent 220, Client 210 sends a request 212 to Server 215 asking to provide it with a list of all available categories. Server 215 processes that request and generates List 220 containing, for example: Categories: “Forms”, “Agreements”, “Legal Opinions”, “Audit”, “Patent Portfolio” Minimum word length: 4 bytes;

Words: “Moscow”, “Document”; Common expressions for dates and times: “20\d\d”, ““\d\d”\w{1,10}20\d\d y.”; Number of shingles: 7;

Precision designator: “Precise” Upon receiving List 220, Client 210 parses 230 subject matter File 225 into character strings 235 using provided common expressions, removes 240 strings having the length less than the minimum word length of four bytes, generates 245 a short, fixed-length binary sequence known as the check value, or CRC, for each of the remaining strings, calculates 250 the length of a resulting shingle based on the number of strings, generates 255 shingle 260 by combining CRC sequences of the remaining strings and produces 265 CRC sequences of the resulting shingle 260, for example, 32424546.

Further referring to FIG. 2, Client 210 transmits Shingle 260 to Server 215 along with the list of categories for the evaluation and additional instructions, for example: Categories: “Forms”, “Agreements”; Size of the shingle: 2; Precision: 60%; CRC: 32424546.

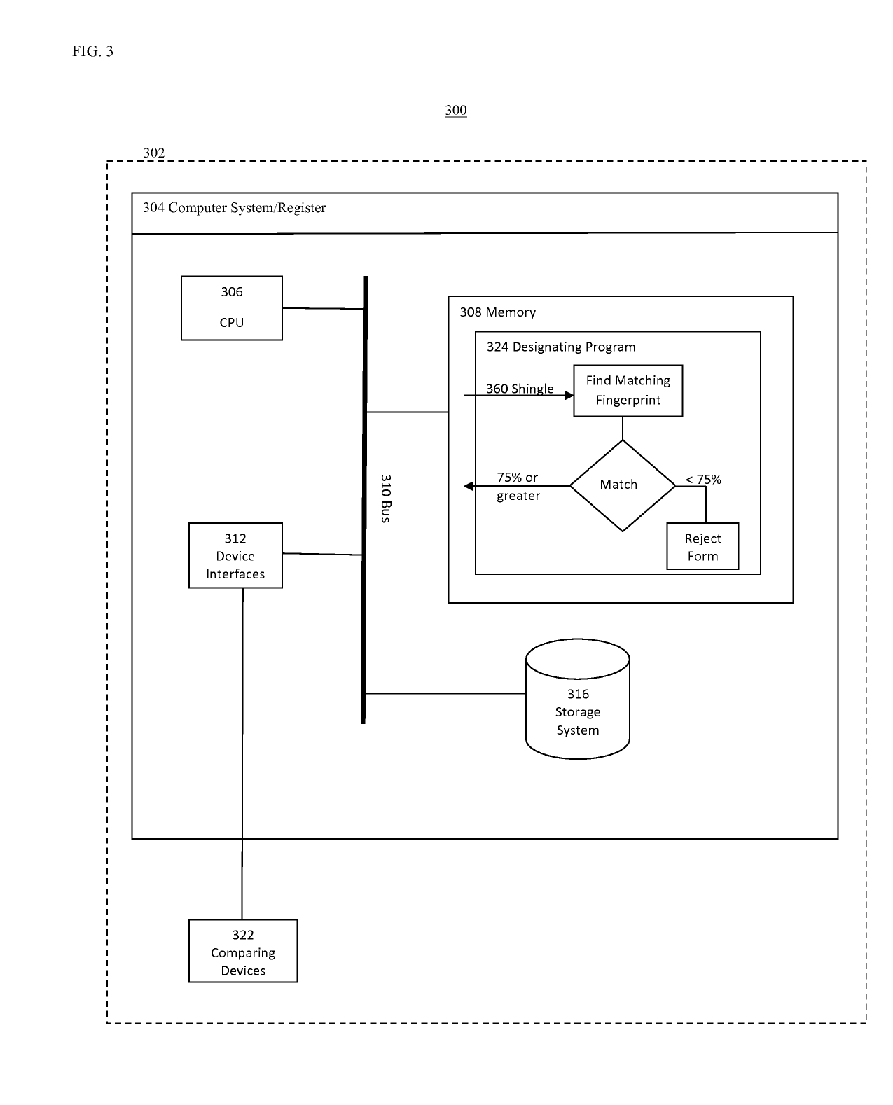

Referring to FIG. 3, it further illustrates a computerized implementation 300 of the present invention. As depicted, implementation 300 includes a computer system 304 deployed within a computer infrastructure 302. This is intended to demonstrate, among other things, that the present invention could be implemented within a network environment (e.g., the Internet, a wide area network (WAN), a local area network (LAN), a virtual private network (VPN), etc.), or on a stand-alone computer system.

In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol and an Internet service provider could be used to establish connectivity to the Internet.

Still yet, computer infrastructure 302 is intended to demonstrate that some or all of the components of implementation 300 could be deployed, managed, serviced, etc., by a service provider who offers to implement, deploy, and/or perform the functions of the present invention for others.

Computer system 304 is shown communicating with one or more comparing devices 322 that communicate with bus 310 via device interfaces 312.

Processing unit 306 collects and routes signals representing outputs from comparing devices 322 to designating program 324. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the network communication may be encrypted using, for example, trusted key-pair encryption.

Different devices may transmit data using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

Upon receiving Shingle 360, Client 310 develops an appropriate course of action according to existing policies. For example, let us presume that the policy prescribes that if a user's file matches category “Forms” by at least 60%, it should be quarantined and the company's data security personnel notified. In our example, since Shingle 360 matches category “Forms” by 75%, it is quarantined, and the company's data security personnel notified.

An exemplary embodiment of the notification may include the name of the file, name of the file's owner and name of the workstation from where the incident occurred.

In general, processing unit 306 executes computer program code, such as program code for executing designating program 324, which is stored in memory 308 and/or storage system 316. While executing computer program code, processing unit 306 can read and/or write data to/from memory 308 and storage system 316. Storage system 316 stores plurality of digital fingerprints generated by processing unit 306, as well as rules and attributes that institute comparing and designating of files;

Although not shown, computer system 304 could also include I/O interfaces that communicate with one or more external devices 318 that enable a user to interact with computer system 304 (e.g., a keyboard, a pointing device, a display, etc.).

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

What is claimed is:

1. Method for identifying and protecting sensitive data contained in a network client file using said file's digital fingerprint, said method comprising:
obtaining plurality of available digital fingerprint categories from a fingerprint-evaluating server;
generating said file's digital fingerprint using said plurality of said digital fingerprint categories obtained from said server;
comparing said generated digital fingerprint to a plurality of digital fingerprints stored in a database;
detecting whether a match between said generated digital fingerprint and at least one of said plurality of said digital fingerprints stored in said database is found, and
designating said file according to established data protection policies.

2. Method according to claim 1, said digital fingerprint is generated by checksum-type algorithms.

3. Method according to claim 1, wherein designating said file according to said established data protection policy further comprises clearing said file as not containing sensitive data.

4. Method as in claim 1, wherein designating said file according to said established data protection policy further comprises quarantining said file as containing sensitive data.

5. System for identifying and protecting sensitive data contained in a network client file using said file digital fingerprint, said system comprising:
at least one processing unit;
memory operably associated with said at least one processing unit;
a generating tool storable in said memory and executable by said processing unit, said generating tool is configured to generate a digital fingerprint of said file using a plurality of digital fingerprint categories obtained from a fingerprint evaluating server;
a detecting tool storable in memory and executable by said at least one processing unit, said detecting tool configured to detect matches between said generated digital fingerprint and at least one of a plurality of digital fingerprints stored in a database;
a designating tool storable in memory and executable by said at least one processing unit, said designating tool is configured to designate said client's file according to established data policies based on said matches between said generated digital fingerprint and said plurality of digital fingerprints stored in said database.

6. The generating tool according to claim 5 further configured to generate said digital fingerprint by a checksum-type algorithms.

7. The designating tool according to claim 5, said established policy further comprising clearing said file as not containing sensitive data.

8. The designating tool according to claim 5, said established policy further comprising quarantining said file as containing sensitive data.

9. Computer-readable medium storing computer instructions, which when executed, enable a computer system to identify and protect sensitive data contained in a network client file using said file's digital fingerprint, comprising computer instructions for:
generating said file's digital fingerprint using a plurality of digital fingerprint categories obtained from a fingerprint-evaluating server;
comparing said generated digital fingerprint to a plurality of digital fingerprints stored in a database;
detecting whether a match between said generated digital fingerprint and at least one of said plurality of digital fingerprints stored in said database is found, and
designating said file according to established data protection policies.

10. The computer-readable medium according to claim 9, further comprising computer instructions to generate said fingerprint by a checksum-type algorithm.

11. The computer-readable medium according to claim 9, said established policy comprises clearing said file as not containing sensitive data.

12. The computer-readable medium according to claim 9, said established policy comprises quarantining said file as containing sensitive data.

13. Method for deploying a tool for identifying and protecting sensitive data contained in a network client file using said file digital fingerprint, said method comprising:
providing a computer infrastructure operable to:
obtain a plurality of available digital fingerprint categories from a fingerprint-evaluating server;
generate digital fingerprint of said file, said generation is done based on said plurality of available digital fingerprint categories obtained from said server;
compare said generated digital fingerprint to a plurality of fingerprints stored in a database;
detect whether a match between said generated digital fingerprint and at least one of said plurality of digital fingerprints stored in said database is found, and
designate said file according to established policies.

14. The method according to claim 13, the computer infrastructure further operable to generate said digital fingerprint by checksum-type algorithms.

15. The method according to claim 13, said established policy further comprises clearing said file as not containing sensitive data.

16. The method according to claim 13, said established policy further comprises quarantining said file as containing sensitive data.
